(19) United States
(12) Patent Application Publication
(10) Pub. No.: US 2013/0208310 A1
(43) Pub. Date: Aug. 15, 2013

(54) INFORMATION PROCESSING SYSTEM, SERVER, CONTROL METHOD, AND STORAGE MEDIUM

(71) Applicant: Canon Kabushiki Kaisha, (US)

(72) Inventor: Kousuke Nakashima, Kawasaki-shi (JP)

(73) Assignee: CANON KABUSHIKI KAISHA, Tokyo (JP)

(21) Appl. No.: 13/752,779

(22) Filed: Jan. 29, 2013

(30) Foreign Application Priority Data
Feb. 13, 2012 (JP) 2012-028347

(51) Int. Cl. H04N 1/00

(52) U.S. Cl. CPC H04N 1/00095
USPC 358/1.15

(57) ABSTRACT

A server accepts a control request for an MFP from a mobile terminal via Internet, and executes control processing for the MFP that functions as a fax device via Internet in response to the accepted control request. Also, the server acquires information addressed to the mobile terminal, which has been received from the fax device to the MFP, from the MFP via Internet and register the acquired information. Then, the server transmits information addressed to the registered mobile terminal to the mobile terminal via Internet.

### BACKGROUND OF THE INVENTION

1. Field of the Invention

The present invention relates to an information processing system, a server, a control method, and a storage medium.

2. Description of the Related Art

In recent years, various types of paperless fax systems have been proposed. The paperless fax systems are intended to reduce costs of paper documents in offices. The use of Internet fax services which perform fax transmission/reception operations from mobile terminals has recently been increasing with the prevalence of mobile terminals such as smart phones. For example, Japanese Patent Laid-Open No. 2004-221722 discloses a fax service system in which, when a fax original document is sent to the selected fax service store, a fax transmission/reception device arranged thereat generates a notification mail for asking a fax receiver to come to the fax service store to receive the original document.

However, the conventional Internet fax services are not configured to control fax devices installed within intranet. Thus, even if Internet fax services are applied, it is difficult for a user to operate his/her terminal at a visit place and confirm a fax document received by an in-house fax device to thereby transmit a document including a delivery date answer or a comment as a reply from the in-house fax device to the other party. Therefore, when a user uses the Internet fax services, the user must perform fax transmission/reception operations using a line number which is different from that of an in-house fax device, resulting in reduction in convenience for the user who owns the in-house fax device.

### SUMMARY OF THE INVENTION

The information processing system of the present invention is adapted to allow a user to control a fax device within intranet by operating a user device.

According to an aspect of the present invention, an information processing system is provided that includes a server device; and a fax device that communicates with the server device via a network. The server device includes a request accepting unit configured to accept a control request for the fax device from a user device via the network; a control processing unit configured to execute control processing for the fax device via the network in response to the accepted control request; an information registering unit configured to acquire, from the fax device via the network, information addressed to the user device, which has been received from another fax device to the fax device, and register the acquired information; and a transmitting unit configured to transmit information addressed to the user device, which has been registered by the information registering unit, to the user device via the network.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of an information processing system of the present embodiment.

FIGS. 2A to 2C are diagrams illustrating an example of the hardware configuration of devices.

FIG. 3 is an exemplary functional block diagram illustrating an MFP.

FIG. 4 is an exemplary functional block diagram illustrating a server.

FIG. 5 is an exemplary functional block diagram illustrating a mobile terminal.

FIG. 6 is a diagram (1) illustrating an example of screen transition displayed by a mobile terminal.

FIG. 7 is a diagram (2) illustrating an example of screen transition displayed by a mobile terminal.

FIG. 8 is a diagram (3) illustrating an example of screen transition displayed by a mobile terminal.

FIG. 9 is a sequence diagram illustrating an example of fax transmission processing.

FIG. 10A is a diagram illustrating an exemplary fax transmission request.

FIG. 10B is a diagram illustrating an exemplary fax transmission response.

FIG. 11A is a diagram illustrating an exemplary fax job acquisition request.

FIG. 11B is a diagram illustrating an exemplary fax job acquisition response.

FIG. 12 is a sequence diagram illustrating an example of fax reception processing.

FIG. 13A is a diagram illustrating an exemplary received fax registration request.

FIG. 13B is a diagram illustrating an exemplary received fax registration response.

FIG. 14 is a diagram illustrating an example of operation processing performed by a server in response to an HTTP request.

### DESCRIPTION OF THE EMBODIMENTS

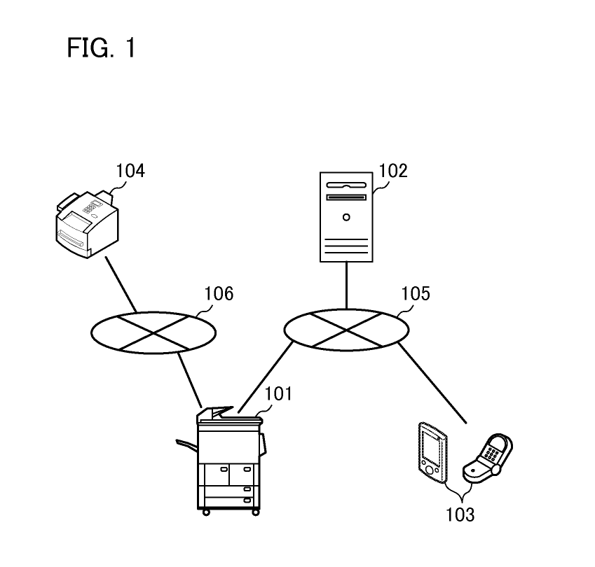

FIG. 1 is a diagram illustrating an example of the configuration of an information processing system of the present embodiment. An MFP (Multifunction Peripheral) 101, a server 102, and a mobile terminal 103 are communicatably connected to each other via Internet 105. In other words, the information processing system of the present embodiment includes the server 102 and the MFP 101 that communicate via the Internet 105. The server 102 is the server device of the present embodiment. The control method of the present embodiment is a method for controlling the server 102. The computer program of the present embodiment causes a computer to execute the control method.

The MFP 101 is located within intranet. Intranet is a network which is used by specific users within a company or the like based on Internet standard technology. Also, the MFP 101 is connected to a fax device 104 via a public line 106 and is capable of transmitting/receiving a fax to/from the fax device 104 (functions as a fax device). The MFP 101 is connected to the Internet 105 via a broadband router or a proxy server, and permits a request from the MFP 101 to the server 102 but denies a request from the server 102 to the MFP 101. A request can neither be made directly from the MFP 101 to the mobile terminal 103 nor be made directly from the mobile terminal 103 to the MFP 101. Thus, the MFP 101 or the mobile terminal 103 realizes indirect mutual communication by utilizing a request to the server 102.

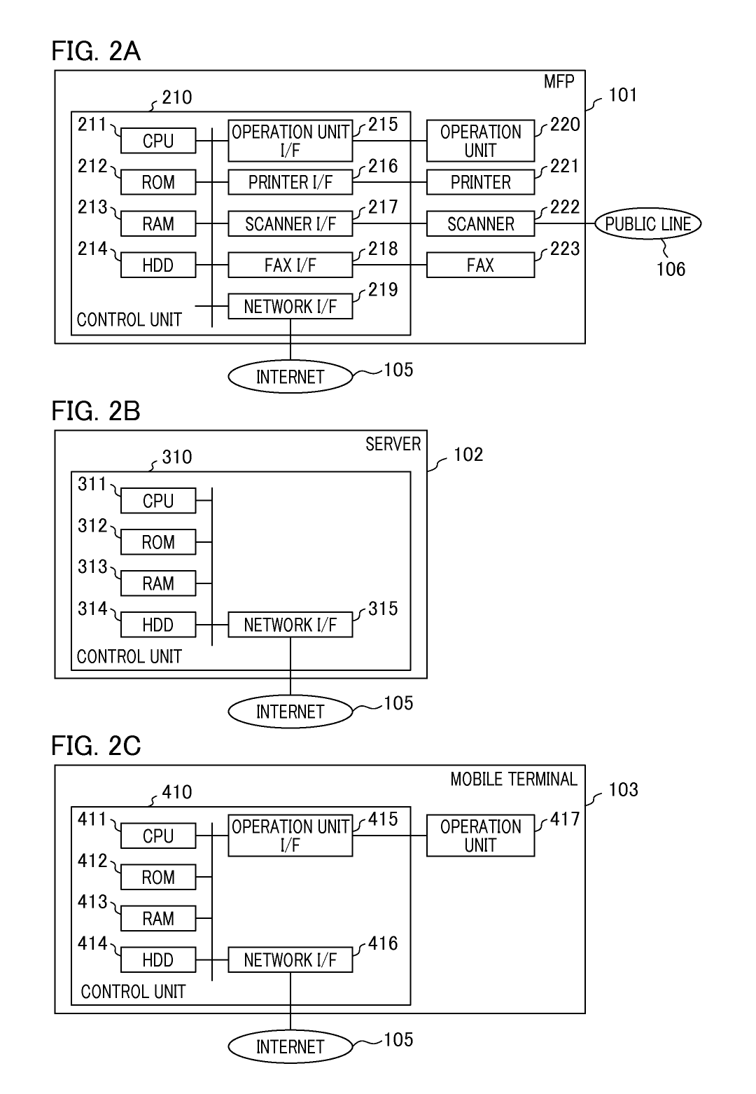

FIGS. 2A to 2C are diagrams illustrating an example of the hardware configuration of an MFP, a server, and a mobile terminal, respectively. FIG. 2A shows an exemplary hardware configuration of an MFP. A control unit 210 including a CPU (Central Processing Unit) 211 controls the operation of the entire MFP 101. The CPU 211 performs various controls such as read control, transmission control, or the like by reading a control program stored in a ROM (Read Only Memory) 212. A RAM (Random Access Memory) 213 is used as a temporary storage area such as a main memory, a work area, or the like for the CPU 211.

An HDD (Hard Disk Drive) 214 stores image data and various programs. An operation unit I/F (Interface) 215 connects an operation unit 220 to the control unit 210. The operation unit 220 is provided with a liquid crystal display unit having a touch panel function, a keyboard, and the like.

A printer I/F 216 connects a printer 221 to the control unit 210. Image data to be printed by the printer 221 is transferred from the control unit 210 via the printer I/F 216 and is printed by the printer 221 onto a recording medium.

A scanner I/F 217 connects a scanner 222 to the control unit 210. The scanner 222 generates image data by reading an image on an original, and inputs the generated image data to the control unit 210 via the scanner I/F 217.

A fax I/F 218 connects a fax 223 to a control unit 210. A fax job to be transmitted by the fax 223 is transferred from the control unit 210 via the fax I/F 218, and is transmitted to a public line by the fax 223. The fax 223 receives fax from a public line.

A network I/F 219 connects the control unit 210 to the Internet 105. The network I/F 219 transmits image data or information to the server 102 on the Internet 105 or receives various pieces of information from the server 102.

FIG. 2B shows an exemplary hardware configuration of a server. A control unit 310 including a CPU 311 controls the operation of the entire server 102. The CPU 311 executes various control processing operations by reading a control program stored in a ROM 312. A RAM 313 is used as a temporary storage area such as a main memory, a work area, or the like for the CPU 311. An HDD 314 stores image data and various programs. A network I/F 315 connects a control unit 310 (the server 102) to the Internet 105. The network I/F 315 transmits/receives various pieces of information to/from other devices on the Internet 105.

FIG. 2C shows an exemplary hardware configuration of a mobile terminal. A control unit 410 including a CPU 411 controls the operation of the entire server 102. The CPU 411 executes various control processing operations by reading a control program stored in a ROM 412. A RAM 413 is used as a temporary storage area such as a main memory, a work area, or the like for the CPU 411. An HDD 414 stores image data and various programs. An operation unit I/F 415 connects an operation unit 417 to the control unit 410. The operation unit 417 is provided with a liquid crystal display unit having a touch panel function, a keyboard, and the like. A network I/F 416 connects the control unit 410 to the Internet 105. The network I/F 416 transmits/receives various pieces of information to/from other devices on the Internet 105.

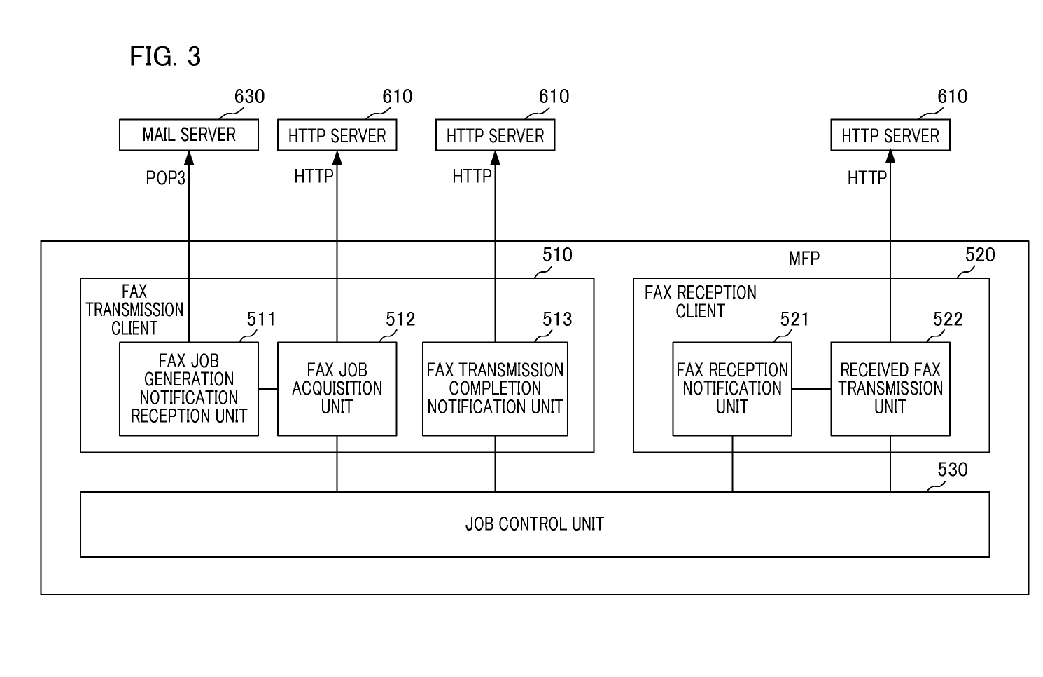

FIG. 3 is an exemplary functional block diagram illustrating an MFP. The functions of the processing units provided in the MFP 101 shown in FIG. 3 are realized by executing a control program stored in the ROM 212 by the CPU 211 provided in the MFP 101.

The MFP 101 includes a fax transmission client 510, a fax reception client 520, and a job control unit 530. The fax transmission client 510 includes a fax job generation notification reception unit 511, a fax job acquisition unit 512, and a fax transmission completion notification unit 513.

The fax job generation notification reception unit 511 receives a fax job generation notification from a mail server 620 at regular intervals in accordance with the POP3 protocol, and instructs the fax job acquisition unit 512 to acquire the notified fax job. The fax job acquisition unit 512 transmits a fax job acquisition request to the HTTP server 610 provided in the server 102 in accordance with the HTTP protocol. Also, the fax job acquisition unit 512 receives a fax job acquisition response from the HTTP server 610. A description will be given below of an example of a fax job acquisition request and its response with reference to FIGS. 11A and 11B. The fax job acquisition unit 512 inputs a fax job included in the fax job acquisition response to the job control unit 530.

The fax transmission completion notification unit 513 transmits a fax transmission completion notification to the HTTP server 610 provided in the server 102 in accordance with the HTTP protocol. When the fax job completion has been reported from the job control unit 530, the fax transmission completion notification unit 513 transmits the fax transmission completion notification to the HTTP server 610.

The fax reception client 520 includes a fax reception notification unit 521 and a received fax transmission unit 522. The fax reception notification unit 521 instructs the received fax transmission unit 522 to transmit received fax information. The fax reception notification unit 521 accepts a fax reception notification from the job control unit 530.

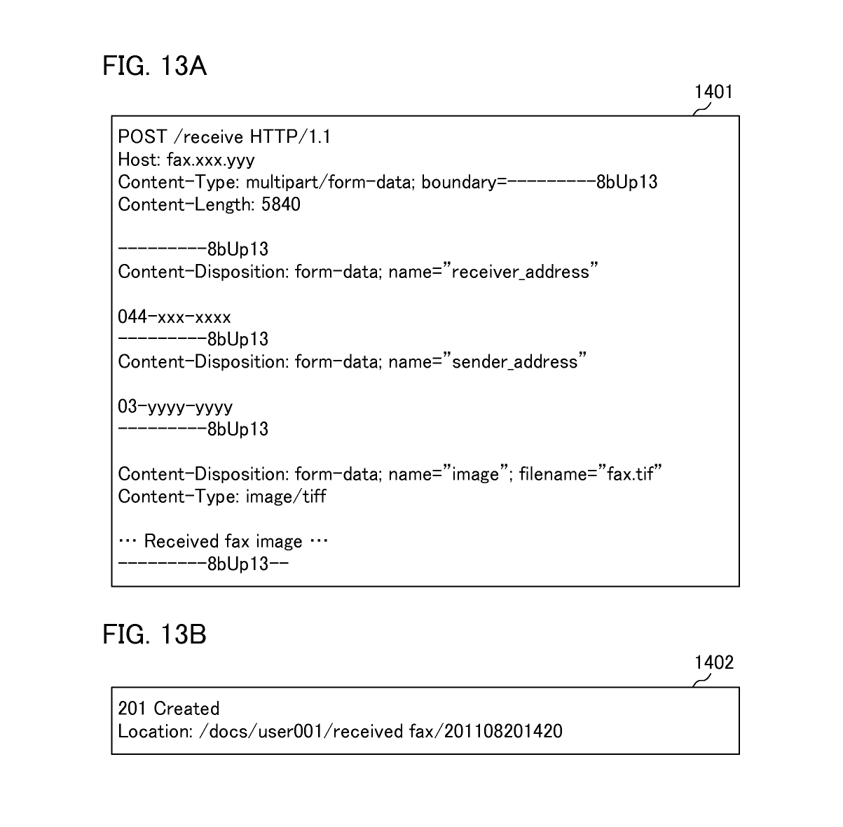

The received fax transmission unit 522 transmits a received fax registration request to the HTTP server 610 in accordance with the HTTP protocol, and receives a received fax registration response. The received fax transmission unit 522 acquires received fax information from the job control unit 530 in accordance with an instruction given by the fax reception notification unit 521, and generates a received fax registration request. A description will be given below of an example of a received fax registration request and its response to be transmitted by the received fax transmission unit 522 with reference to FIG. 13.

The job control unit 530 accepts the input of a fax job from the fax job acquisition unit 512. The job control unit 530 processes a fax job and executes fax transmission. Upon completion of fax transmission, the job control unit 530 notifies the fax transmission completion notification unit 513 of job completion. Upon receiving a fax, the job control unit 530 notifies the fax reception notification unit 521 of a fax reception, and responds received fax information in response to the instruction given by the received fax transmission unit 522.

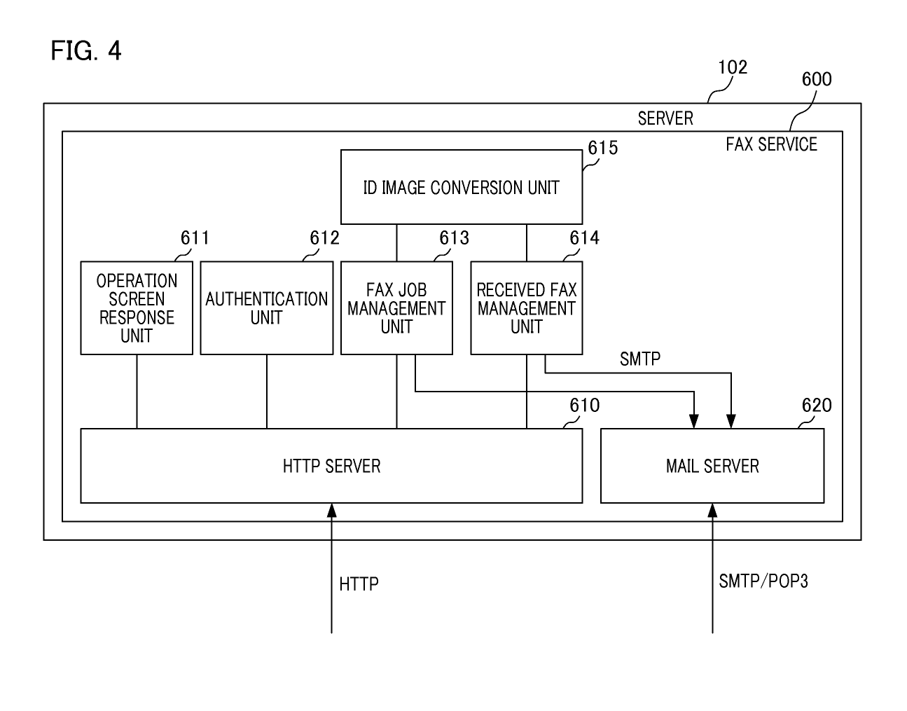

FIG. 4 is an exemplary functional block diagram illustrating a server. The functions of the processing units provided in the server 102 shown in FIG. 4 are realized by executing a control program stored in the ROM 312 by the CPU 311 provided in the server 102.

The server 102 includes a fax service 600. The fax service 600 includes an HTTP server 610, an operation screen response unit 611, an authentication unit 612, a fax job management unit 613, a received fax management unit 614, an ID image conversion unit 615, and a mail server 620.

The HTTP server 610 receives an HTTP request from the MFP 101 or the mobile terminal 103, and transmits an HTTP response. The HTTP server 610 assigns an HTTP request to the operation screen response unit 611, the authentication unit 612, the fax job management unit 613, or the received fax management unit 614 in accordance with the content of the received HTTP request.

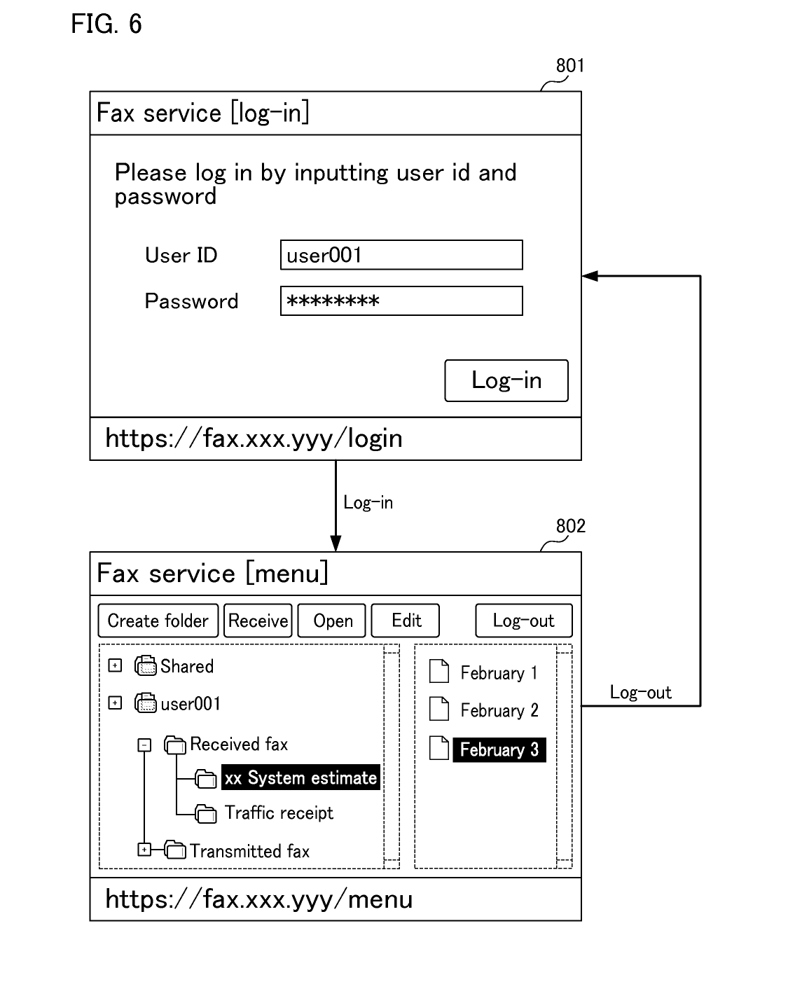

The operation screen response unit 611 responds an HTML representing an operation screen in response to an operation screen acquisition request from the mobile terminal 103. A description will be given below of an exemplary operation screen to be displayed on the operation unit 417 of the mobile terminal 103 with reference to FIGS. 6 to 8.

The authentication unit 612 performs authentication processing in response to an authentication request from the mobile terminal 103. More specifically, the authentication unit 612 receives a log-in request including a user ID and a password from the mobile terminal 103. Then, the authentication unit 612 performs user authentication using the user ID and the password. When the user authentication was successful, the authentication unit 612 generates session information, sets a session ID to an HTTP response header Cookie and responds to the mobile terminal 103. Also, the authentication unit 612 receives a log-out request including the session ID from the mobile terminal 103, and deletes session information.

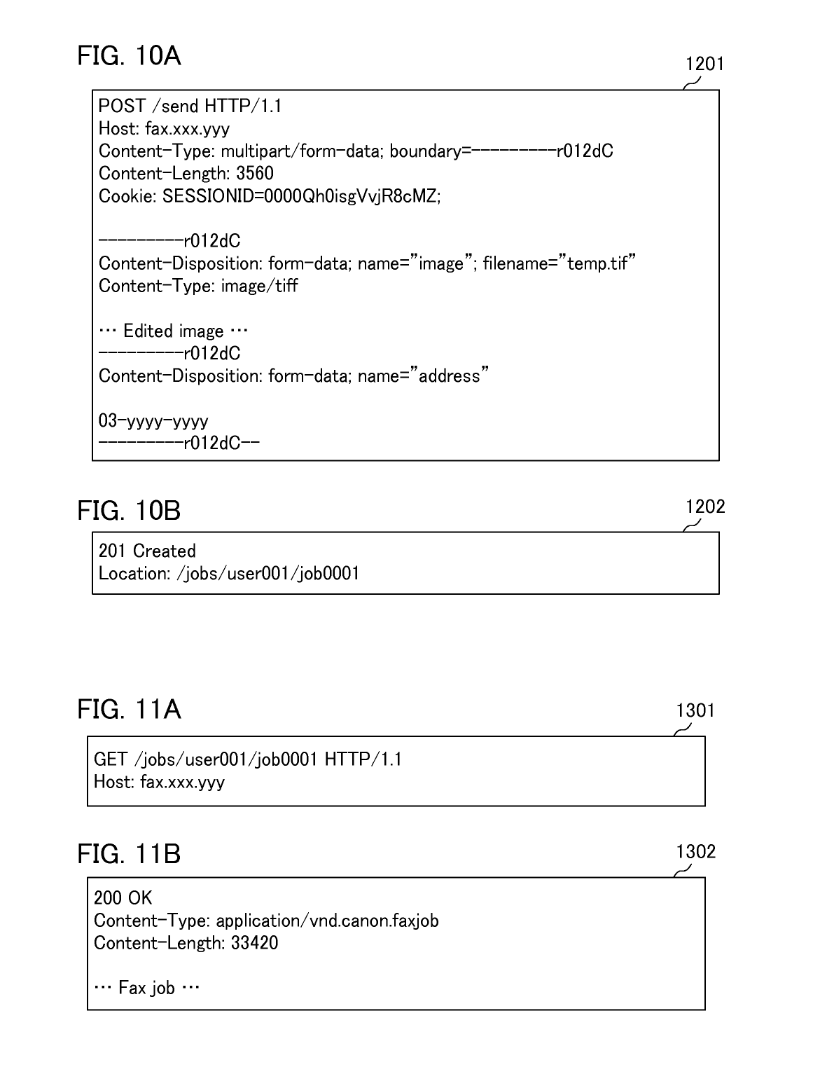

The fax job management unit 613 generates a fax job in response to a fax transmission request from the mobile terminal 103, and responds a fax job generation response. The fax transmission request is a request for inputting a fax job to the MFP 101. The fax transmission request is an exemplary control request made by the fax device (the MFP 101) of the present embodiment. In other words, the fax job management unit 613 functions as a request accepting unit that accepts a control request for the MFP 101 from the mobile terminal 103 via the network. A description will be given below of an example of a fax transmission request and its response with reference to FIGS. 10A and 10B.

The fax job management unit 613 responds a fax job acquisition response in response to a fax job acquisition request from the MFP 101. In this example, the fax job acquisition response includes a fax job. Also, the fax job management unit 613 responds a fax transmission completion notification response to the mobile terminal 103 in response to a fax transmission completion notification from the MFP 101.

When the fax job generation response is responded to the mobile terminal 103, the fax job management unit 613 transmits a fax job generation notification for providing a notification to the MFP 101 to the mail server 620 in accordance with the SMTP protocol. Upon responding a fax job completion notification response, the fax job management unit 613 transmits a fax job completion notification for providing a notification to the mobile terminal 103 to the mail server 620 in accordance with the SMTP protocol. Furthermore, the fax job management unit 613 generates a composed image by composing an ID image generated by the ID image conversion unit 615 with a fax transmission image, and generates a fax job based on the composed image. In other words, the fax job management unit 613 generates a fax job including identification information about a user who operates the mobile terminal 103 of the request source of a control request for controlling the MFP 101.

The received fax management unit 614 registers received fax information in response to a fax job registration request from the MFP 101, and responds a fax job registration response. Upon responding the fax job registration response to the MFP 101, the received fax management unit 614 transmits a fax reception notification for providing a notification to the mobile terminal 103 to the mail server 620 in accordance with the SMTP protocol. Also, the received fax management unit 614 identifies an ID image from the received fax image, and instructs the ID image conversion unit 615 to acquire a user ID.

The ID image conversion unit 615 converts the user ID authenticated by the authentication unit 612 to an ID image. Also, the ID image conversion unit 615 converts the ID image identified by the received fax management unit 614 into a user ID.

The mail server 620 receives a fax job generation notification and a fax job completion notification from the fax job management unit 613 in accordance with the SMTP protocol. The mail server 620 receives a fax reception notification from the received fax management unit 614 in accordance with the SMTP protocol.

The mail server 620 transmits a fax job generation notification to the MFP 101 in accordance with the POP3 protocol. Furthermore, the mail server 620 transmits a fax job completion notification and a fax reception notification to the mobile terminal 103 in accordance with the POP3 protocol. In other words, the mail server 620 has a mail account for the MFP 101 and a mail account for the mobile terminal 103.

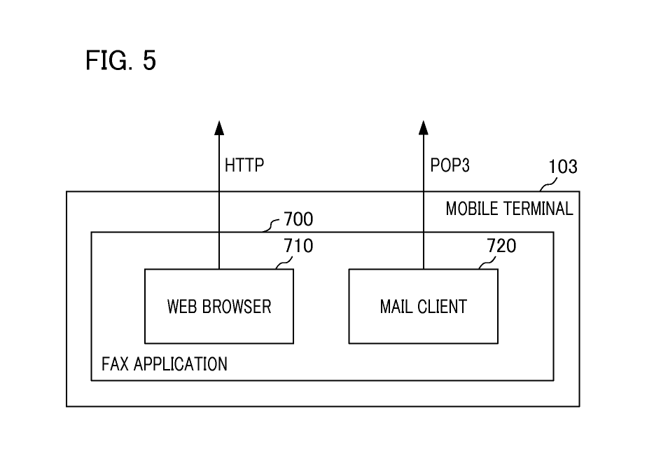

FIG. 5 is an exemplary functional block diagram illustrating a mobile terminal. The functions of the processing units provided in the mobile terminal 103 shown in FIG. 5 are realized by executing a control program stored in the ROM 412 by the CPU 411 provided in the mobile terminal 103.

The mobile terminal 103 includes a fax application 700. The fax application 700 includes a Web browser 710 and a mail client 720. The fax application 700 executes fax transmission/reception processing by controlling the Web browser 710 and the mail client 720.

The Web browser 710 requests an operation screen to the server 102 in accordance with the HTTP protocol. The Web browser 710 displays the received operation screen on the operation unit 417, and redraws the operation screen or transmits an HTTP request to the server 102 in accordance with the input instruction given by the operation unit 417. The mail client 720 receives a fax job completion notification or a fax reception notification from the server 102 in accordance with the POP3 protocol.

FIGS. 6 to 8 are diagrams illustrating an example of screen transition displayed by a mobile terminal. Each of the screens shown in FIGS. 6 to 8 is displayed by processing through the fax application 700 of an HTML content responded by the server 102 0. Hereinafter, a description will be given of the screens in sequence.

A log-in screen 801 shown in FIG. 6 is a screen used for logging in the fax service 600. The log-in screen 801 includes a user ID input field, a password input field, and a log-in button. The user ID input field is a text field for inputting a user ID. The password input field is a password field for inputting a password. The log-in button is a button for transmitting a log-in request to the fax service 600. When the log-in button is pressed down and the authentication of the fax service 600 was successful, the fax application 700 transitions a display screen from the log-in screen 801 to the menu screen 802.

The menu screen 802 is a screen that displays a menu provided by the fax service 600. The menu screen 802 includes a folder create button, a receive button, an open button, an edit button, a log-out button, a folder list, and a file list. The folder create button is a button for adding a folder to the folder list.

The receive button is a button for instructing fax reception to the fax service 600. The open button is a button for instructing displaying of a file selected from the file list. The edit button is a button for instructing editing of a file selected from the file list. The log-out button is a button for requesting a log-out to the fax service 600. The folder list is a display area for displaying a list of folders.

A folder includes a shared folder corresponding to the MFP 101 used by users and a user folder corresponding to a log-in user. The shared folder is a folder that is shared by users who use the MFP 101. The user folder is a folder dedicated for a log-in user. Under the shared folder or the user folder, at least a received fax folder and a transmitted fax folder are placed.

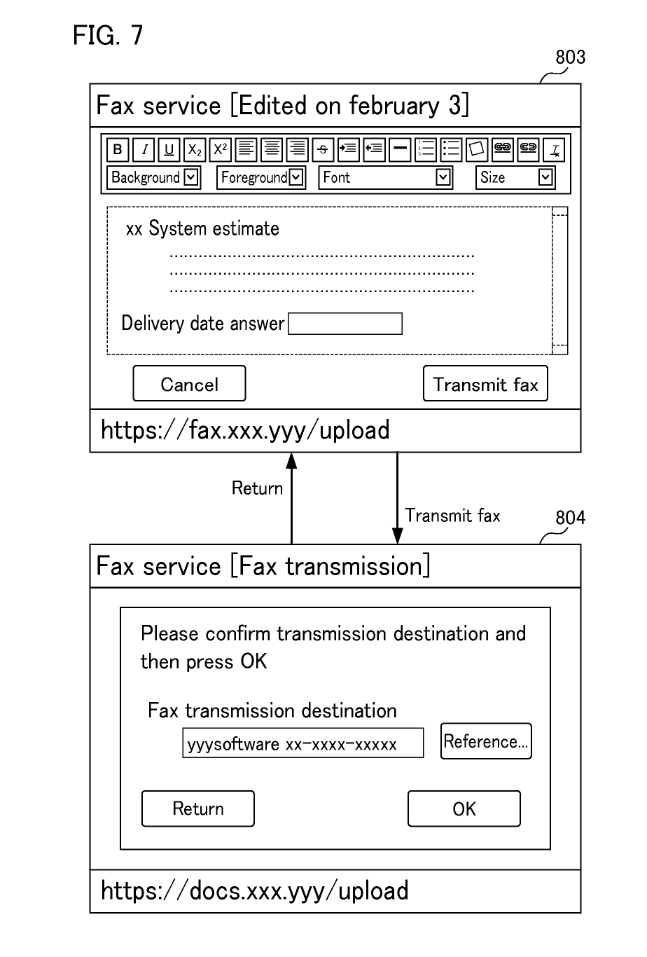

When a folder is selected from the folder list, a list of files in the folder is displayed on the file list. When a file is selected from the file list and the edit button is pressed down, the fax application 700 transitions the display screen from the menu screen 802 to an edit screen 803 shown in FIG. 7. When the log-out button is pressed down, the fax application 700 transitions the display screen from the menu screen 802 to the log-in screen 801.

The edit screen 803 shown in FIG. 7 is a screen on which a comment or the like is entered into a received fax for reply. Various types of editor functions are included in the edit screen 803, where a comment can be entered as text on a received fax image. FIG. 7 shows the edit screen 803 when a delivery date is entered in an estimate received by fax. The edit screen 803 has a cancel button and a fax transmission button.

When the cancel button is pressed down, the fax application 700 transitions the display screen from the edit screen 803 to the menu screen 802 shown in FIG. 6. When the fax transmission button is pressed down, the fax application 700 transitions the display screen from the edit screen 803 to a fax transmission screen 804.

The fax transmission screen 804 is a screen for instructing fax transmission. The fax transmission screen 804 has a fax transmission destination field for inputting a fax transmission destination telephone number, a return button, and an OK button. A transmission source telephone number included in the received fax information in advance is preset on the fax transmission destination field. When a user presses down the OK button, a reply can be transmitted back to the transmission source of the received fax.

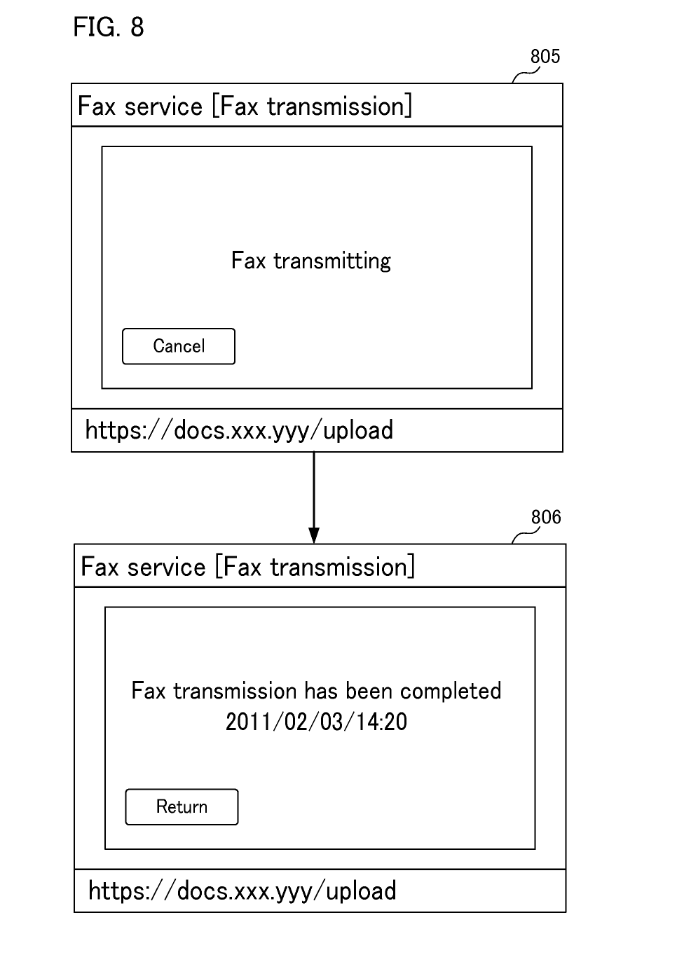

When the OK button is pressed down, the fax application 700 transitions the display screen from the fax transmission screen 804 to a fax transmitting screen 805 shown in FIG. 8. When the return button is pressed down, the fax application 700 transitions the display screen from the fax transmission screen 804 to the edit screen 803.

The fax transmitting screen 805 shown in FIG. 8 is a screen for displaying information indicating the fact that the fax is being transmitted. The fax transmitting screen 805 includes a cancel button. When the cancel button is pressed down, the fax application 700 instructs the fax service 600 to cancel fax transmission and transitions the display screen from the fax transmitting screen 805 to the menu screen 802. When the fax application 700 is notified of the completion of fax transmission from the fax service 600, the fax application 700 transitions the display screen from the fax transmitting screen 805 to a fax transmission completed screen 806.

The fax transmission completed screen 806 is a screen for displaying information indicating the completion of fax transmission. The fax transmission completed screen 806 includes a return button. When the return button is pressed down, the fax application 700 transitions the display screen from the fax transmission completed screen 806 to the menu screen 802 shown in FIG. 6.

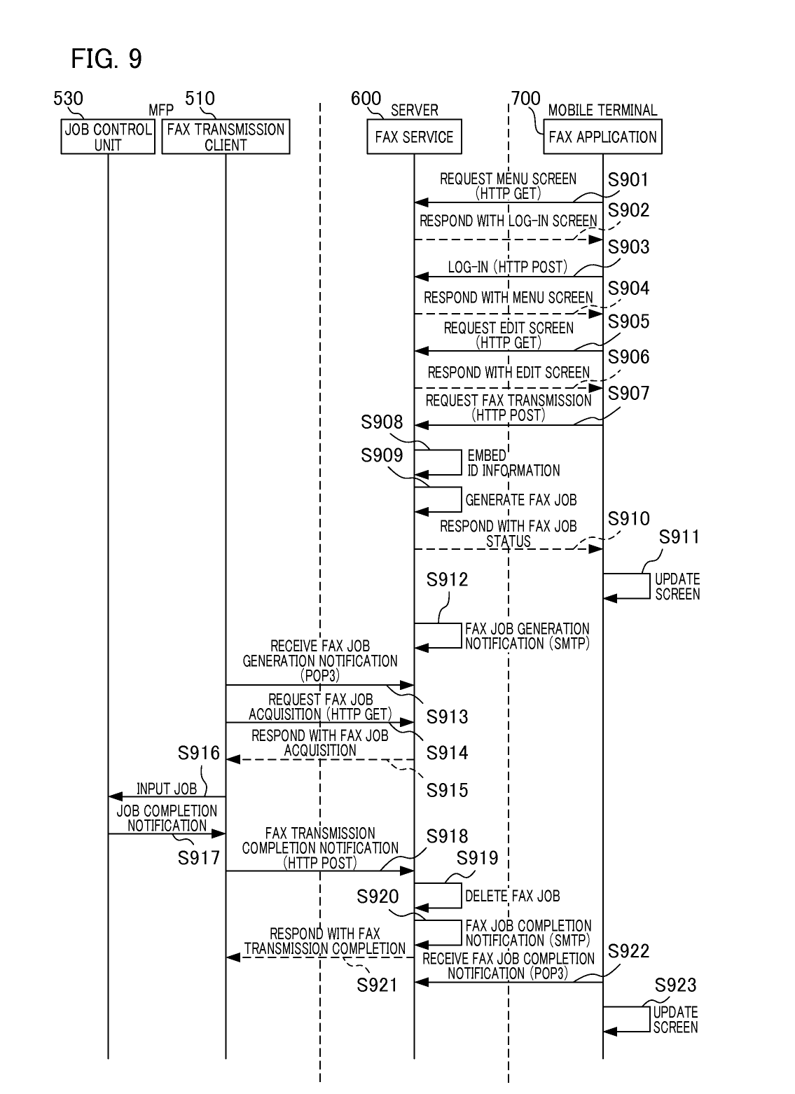

FIG. 9 is a sequence diagram illustrating an example of fax transmission processing executed by the information processing system of the present embodiment. Firstly, the fax application 700 transmits an HTTP request (GET method) for requesting the menu screen 802 to the fax service 600 (step S901). Next, the fax service 600 transmits an HTTP response for sending the log-in screen 801 as a response to the fax application 700 (step S902).

Next, when the log-in button on the log-in screen 801 is pressed down, the fax application 700 transmits an HTTP request (POST method) for requesting log-in to the fax service 600 (step S903). The fax service 600 performs authentication processing for the requested user and then generates session information.

Next, the fax service 600 transmits an HTTP response for sending the menu screen 802 as a response to the fax application 700 (step S904). In step S904, the fax service 600 sets a session ID to an HTTP response header Cookie. In this manner, HTTP communication between the fax service 600 and the fax application 700 in the subsequent steps is performed in the same session.

Next, when the edit button on the menu screen 802 is pressed down, the fax application 700 transmits an HTTP request (GET method) for requesting the edit screen 803 to the fax service 600 (step S905). Then, the fax service 600 transmits an HTTP response for sending the edit screen 803 as a response to the fax application 700 (step S906).

Next, when the OK button on the fax transmission screen 804 is pressed down after transition of the display screen from the edit screen 803 to the fax transmission screen 804 in response to a user's input operation, the fax application 700 executes the following processing. The fax application 700 transmits an HTTP request (POST method) for requesting fax transmission to the fax service 600 (step S907).

Next, the fax service 600 composes an image requested for fax transmission with an ID image of a log-in user to thereby generate an image for fax transmission (step S908). Then, the fax service 600 generates a fax job for fax-transmitting the image for fax transmission generated in step S908 to the transmission destination telephone number requested in step S907 (step S909). In other words, the ID image conversion unit 615 and the fax job management unit 613 (FIG. 4) collectively function as a generating unit that generates a fax job including image information in which user identification information is embedded as visible information.

Next, the fax service 600 transmits an HTTP response (fax job status response) for sending a fax transmission request as a response to the fax application 700 (step S910).

FIGS. 10A and 10B are diagrams illustrating examples of a fax transmission request and a fax transmission response, respectively. FIG. 10A shows an exemplary fax transmission request. FIG. 10B shows an exemplary fax transmission response. The entity body of a fax transmission request 1201 shown in FIG. 10A is encoded with multipart/form-data. The entity body includes an edition image input on the edit screen 803 and a fax transmission destination telephone number “044-xxx-xxxx” input on the fax transmission screen 804.

The entity body of a fax transmission response 1202 shown in FIG. 10B includes a Location header for setting URI “/jobs/user001/job0001” for the fax job generated as the result of the fax transmission request.

Referring back to FIG. 9, the fax application 700 displays the fax transmitting screen 805. Next, the fax service 600 transmits a fax job generation notification to the mail server 620 (step S912). The fax job generation notification includes a fax job URI.

Next, the fax transmission client 510 receives the fax job generation notification transmitted in step S912 from the mail server (step S913). Next, the fax transmission client 510 transmits an HTTP request (GET method) for requesting acquisition of a fax job corresponding to the fax job URI to the fax service 600 (step S914). The fax service 600 generates a fax job acquisition response (HTTP response) including the fax job generated in step S909, and transmits the fax job acquisition response to the fax transmission client 510 (step S915). In other words, the fax job management unit 613 of the fax service 600 functions as a control processing unit that executes the following processing. The fax job management unit 613 executes MFP control processing, i.e., fax job generation processing and fax job input processing in response to the fax transmission request which is the control request accepted from the mobile terminal. The fax job input processing is processing for inputting a fax job to the MFP 101 for execution.

FIGS. 11A and 11B are diagrams illustrating examples of a fax job acquisition request and a fax job acquisition response, respectively. FIG. 11A shows an exemplary fax job acquisition request. FIG. 11B shows an exemplary fax job acquisition response.

A fax job acquisition request 1301 shown in FIG. 11A is a request for acquisition of a fax job corresponding to the fax job URI “/jobs/user001/job0001”. The entity body of a fax job acquisition response 1302 shown in FIG. 11B includes a fax job.

Referring back to FIG. 9, the fax transmission client 510 inputs a fax job included in the fax job acquisition response to the job control unit 530 (step S916). When execution of the fax job is completed, the job control unit 530 provides a fax job completion notification to the fax transmission client 510 (step S917).

Next, the fax transmission client 510 transmits the fax transmission completion notification to the fax service 600 (step S918). The fax transmission completion notification is made by the HTTP request (POST method). The fax transmission completion notification includes a fax job URI.

Next, the fax service 600 deletes a fax job designated by the fax transmission completion notification (represented by the fax job URI) (step S919). Then, the fax service 600 transmits the fax job completion notification to the mail server 620 in accordance with the SMTP protocol (step S920). The fax job completion notification includes a fax job URI.

Next, the fax service 600 transmits an HTTP response for sending the completion of fax transmission as a response to the fax transmission client 510 (step S921). Next, the fax application 700 receives the fax job completion notification from the fax service 600 in accordance with the POP3 protocol (step S922). Then, the fax application 700 displays the fax transmission completed screen 806 (step S923).

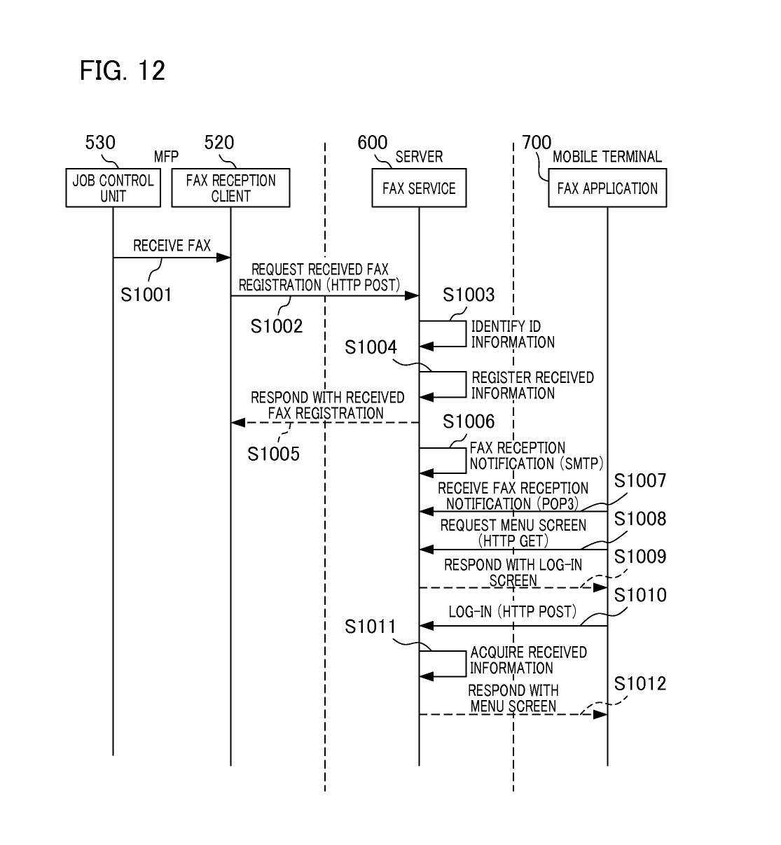

FIG. 12 is a sequence diagram illustrating an example of fax reception processing executed by the information processing system of the present embodiment. Firstly, the job control unit 530 notifies the fax reception client 520 of fax reception (step S1001). Next, the fax reception client 520 transmits an HTTP request (POST method) for requesting received fax registration to the fax service 600 (step S1002).

Next, the fax service 600 acquires an ID image from the received image included in the received fax registration request, and identifies a user ID based on the acquired ID image (step S1003). Next, the fax service 600 registers received fax information included in the received fax registration request in association with the user ID identified in step S1003 (step S1004). In other words, the received fax management unit 614 provided in the fax service 600 functions as an information registering unit that executes the following processing. The received fax management unit 614 acquires received fax information addressed to the user device (addressed to the mobile terminal 103), which has been received from the fax device 104 (FIG. 1) to the MFP 101, from the MFP 101 via the network and register the acquired information. When the user ID cannot be identified in step S1003, the fax service 600 registers received fax information in association with the fax line number of the MFP 101. Next, the fax service 600 transmits a received fax registration response (HTTP response) to the fax reception client 520 (step S1005). Instead of the processes in steps S1001 and S1002 shown in FIG. 12, the fax service 600 may also function as an acquiring unit that performs fax reception (acquires a fax job). In step S1004, the fax service 600 may also register identification information (user ID) included in the received image of the acquired fax job in association with the received image.

FIGS. 13A and 13B are diagrams illustrating examples of a received fax registration request and a received fax registration response. FIG. 13A shows an exemplary received fax registration request. FIG. 13B shows an exemplary received fax registration response. The entity body of a received fax registration request 1401 shown in FIG. 13A is encoded with multipart/form-data. The entity body includes “044-xxx-xxxx” as the fax receiver telephone number, i.e., the telephone number of the MFP 101. The entity also includes “03-yyyy-yyyy” as the fax transmitter telephone number, i.e., the telephone number of the fax device 104. The entity also includes a received fax image.

The entity body of a received fax registration response 1402 shown in FIG. 13B includes a Location header. As an example, the URI “/docs/user001/received fax/201108201420” of received fax information registered in response to the fax registration request 1401 is set to the Location header.

Referring back to FIG. 12, the fax service 600 transmits a fax reception notification to the mail server 620 in accordance with the SMTP protocol (step S1006). The fax reception notification includes the URI of received fax information. In the form where the fax service 600 registers the received image in association with the user ID in step S1004 shown in FIG. 12, the fax service 600 functions as a notifying unit that provides a notification to a user corresponding to the user ID. Next, the fax application 700 receives the fax reception notification in accordance with the POP3 protocol (step S1007).

The processes in steps S1008 to S1010 are the same as those in steps S901 to S903 shown in FIG. 9, and explanation thereof will be omitted. Next, the fax service 600 acquires received fax information registered in association with the fax receiver telephone number (the MFP 101) and received fax information registered in association with the user ID of a log-in user (step S1011).

The fax service 600 generates screen information corresponding to the menu screen 802 based on the received fax information acquired in step S1011. The screen information includes the received fax information. Then, the fax service 600 transmits the generated screen information as an HTTP response to the fax application 700 (step S1012). In other words, the operation screen response unit 611 provided in the fax service 600 functions as a transmitting unit that transmits the received fax information addressed to the mobile terminal 103 to the mobile terminal 103 via the Internet 105. In this example, the operation screen response unit 611 transmits screen information including received fax information to the mobile terminal 103 in response to the request (menu screen request) from the mobile terminal 103 operated by a user who has received the fax reception notification.

The fax application 700 functions as a displaying unit that displays a menu screen 802 based on the received screen information. The menu screen 802 is a screen which is adapted to edit a fax image corresponding to the received fax information included in the received screen information, where a control request for the MFP 101 is made by a user on the screen. The fax application 700 functions as a requesting unit that executes the following processing. The fax application 700 edits the fax image in accordance with a user's operation on the menu screen. Also, the fax application 700 transmits a fax transmission request for instructing the transmission of a fax job corresponding to the edited fax image to the MFP 101 to the fax job management unit 613 provided in the server 102 (see step S907 shown in FIG. 9).

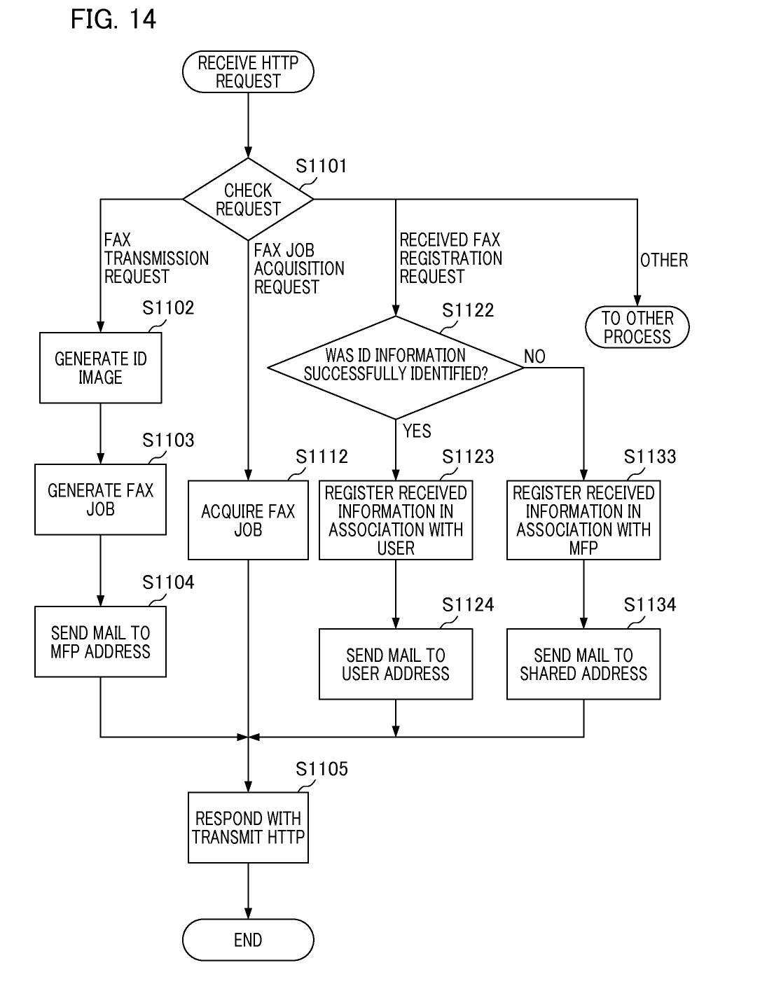

FIG. 14 is a flowchart illustrating an example of operation processing performed by a server in response to an HTTP request. Firstly, the fax service 600 checks the request URI of an HTTP request. When the HTTP request is the fax transmission request 1201, the process advances to step S1102. When the HTTP request is the fax job acquisition request 1301, the process advances to step S1112. When the HTTP request is the received fax registration request 1401, the process advances to step S1122. When the HTTP request is any other request, processing in response to the request (explanation thereof is omitted) is executed.

In step S1102, the fax service 600 generates an ID image based on information about the log-in user ID (step S1102). Next, the fax service 600 generates a fax job based on the fax transmission request and the ID image (step S1103).

Next, the fax job management unit 613 provided in the fax service 600 generates a mail for reporting fax job generation to the mail address of the MFP 101, and transmits the mail to the mail server 620 (step S1104). In step S1105, the fax service 600 transmits an HTTP response for responding to each HTTP request (step S1105), and the process ends.

In step S1112, the fax service 600 acquires the generated fax job designated by the fax job URI (step S1112), and the process advances to step S1105.

In step S1122, the received fax management unit 614 provided in the fax service 600 determines whether or not an ID image was successfully identified from the designated received fax image (whether or not received fax information includes user identification information) (step S1122). If an ID image was successfully identified by the fax service 600, the process advances to step S1123. If an ID image was unsuccessfully identified by the fax service 600, the process advances to step S1133.

In step S1123, the fax service 600 registers the received fax information in association with a user ID corresponding to the identified ID image (step S1123). In other words, when the received fax information includes user identification information, the received fax management unit 614 registers the received fax information in association with the user identification information. Then, the fax service 600 generates a mail for reporting fax reception to the mail address, which is associated with the user ID, of the mobile terminal 103, and transmits the mail to the mail server 620 (step S1124). In other words, the mail server 620 functions as a notifying unit that executes the following processing. The mail server 620 sends a fax reception notification to the address of the user using the fact that the received fax management unit 614 has registered the received fax information in association with the user ID as a trigger. The fax reception notification transmitted in step S1124 can only be received by the mobile terminal 103 for a specific user. In this manner, the fact that the MFP 101 has received fax can be reported to a user only corresponding to the received fax information. When the process in step S1124 ends, the process advances to step S1105.

In step S1133, the fax service 600 registers the received fax information in association with the fax line number of the MFP 101. In other words, when the received fax information does not include user identification information, the received fax management unit 614 manages the received fax information in association with the fax device (the MFP 101) of the acquisition source of the received fax information. When the process in step S1133 ends, the process advances to step S1134.

In step S1134, the fax service 600 generates a mail for reporting fax reception to the mail address, which is common to users who use the MFP 101, of the mobile terminal 103, and transmits the mail to the mail server 620 (step S1134). In other words, the mail server 620 sends a fax reception notification to an address common to users who use the MFP 101 using the fact that the received fax management unit 614 has registered the received fax information in association with the fax line number of the MFP 101 as a trigger. The fax reception notification transmitted in step S1134 can be received by all the mobile terminals 103 utilizing the MFP 101. When the process in step S1134 ends, the process advances to step S1105.

According to the information processing system of the present embodiment described above, the server 102 accepts a control request for the MFP 101 from the mobile terminal 103 via the Internet 105, and executes control processing for the MFP 101 in response to the accepted control request. For example, the server 102 accepts a fax transmission request from the mobile terminal 103, and generates a fax job to thereby input the generated fax job to the MFP 101 for execution. Also, when the server 102 receives received fax information addressed to a user of the mobile terminal 103, the server 102 provides a fax reception notification to the user. Then, the server 102 transmits screen information including the received fax information to the mobile terminal 103 in response to a request from the mobile terminal 103 operated by the user. In this manner, a user can control a fax device within intranet, and can perform fax transmission/reception operations using an in-house MFP even if the user is at a visit place.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via the network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-028347 filed on Feb. 13, 2012, which is hereby incorporated by reference herein in its entirety.

What is claimed is:

1. An information processing system comprising:
a server device; and
a fax device that communicates with the server device via a network,
wherein the server device comprises:
a request accepting unit configured to accept a control request for the fax device from a user device via the network;
a control processing unit configured to execute control processing for the fax device via the network in response to the accepted control request;
an information registering unit configured to acquire, from the fax device via the network, information addressed to the user device, which has been received from another fax device to the fax device, and register the acquired information; and
a transmitting unit configured to transmit information addressed to the user device, which has been registered by the information registering unit, to the user device via the network.

2. The information processing system according to claim 1, wherein, when the control request accepted by the request accepting unit is a fax transmission request, the control processing unit generates a fax job in response to the fax transmission request and causes the fax device to execute the fax job.

3. The information processing system according to claim 2, wherein the control processing unit generates a fax job including identification information about a user who operates a user device of the request source of the control request,
wherein the information registering unit acquires received fax information as information addressed to the user device, determines whether or not the received fax information includes the user identification information, and, when the received fax information includes the user identification information, the information registering unit registers the received fax information in association with the user identification information, and
wherein the server device further comprises a notifying unit configured to send a fax reception notification to the address of the user using the fact that the information registering unit has registered the received fax information in association with the user identification information as a trigger.

4. The information processing system according to claim 2, wherein, when the received fax information does not include the user identification information, the information registering unit registers the received fax information in association with a fax device of the acquisition source of the received fax information, and
wherein the notifying unit sends a fax reception notification to an address common to users who use the fax device using the fact that the information registering unit has registered the received fax information in association with a fax device of the acquisition source of the received fax information as a trigger.

5. The information processing system according to claim 2, wherein the transmitting unit transmits screen information including the received fax information to the user device in response to a request from a user device operated by a user who has received the fax reception notification.

6. The information processing system according to claim 5, wherein the user device comprises:
a displaying unit configured to display a menu screen for making a control request for the fax device, which is adapted to edit a fax image corresponding to the received fax information included in screen information, based on the screen information received from the transmitting unit provided in the server device; and
a requesting unit configured to edit a fax image corresponding to the received fax information in accordance with a user's operation on the menu screen and transmit a fax transmission request for instructing the transmission of the edited fax image to the fax device to the request accepting unit provided in the server device.

7. A method for controlling a fax device provided in a system comprising a server device and a fax device that communicates with the server device via a network, the method by the server device comprising:
accepting a control request for the fax device from a user device via the network;
executing control processing for the fax device via the network in response to the accepted control request;
acquiring, from the fax device via the network, information addressed to the user device, which has been received from another fax device to the fax device, and registering the acquired information; and
transmitting the registered information addressed to the user device to the user device via the network.

8. A non-transitory storage medium on which is stored a computer program for making a computer execute a method for controlling a fax device provided in a system comprising a server device and a fax device that communicates with the server device via a network, the method by the server device comprising:
accepting a control request for the fax device from a user device via the network;
executing control processing for the fax device via the network in response to the accepted control request;
acquiring, from the fax device via the network, information addressed to the user device, which has been received from another fax device to the fax device, and registering the acquired information; and
transmitting, by the server device, the registered information addressed to the user device to the user device via the network.

9. A server comprising:
a generating unit configured to generate a fax job including image information in which user identification information is embedded as visible information;
an acquiring unit configured to acquire the fax job; and
a notifying unit configured to provide a notification to a user corresponding to identification information included in the received image of the acquired fax job.
